(19) United States
(12) Patent Application Publication
(10) Pub. No.: US 2026/0342269 A1
(43) Pub. Date: Oct. 29, 2026

(54) ELECTRIC MOTOR DRIVING APPARATUS

(71) Applicant: SUBARU CORPORATION, Tokyo (JP)

(72) Inventor: Kimihiro NAGASE, Tokyo (JP)

(21) Appl. No.: 19/631,480

(22) Filed: Mar. 27, 2026

(30) Foreign Application Priority Data
Apr. 3, 2025 (JP) 2025-061672

(51) Int. Cl. H02P 29/028

(52) U.S. Cl. CPC H02P 29/028

(57) ABSTRACT

An electric motor driving apparatus includes an electric motor, an inverter, and a processor. The electric motor includes a stator including a set of stator windings of multiple phases, the stator windings being coupled to each other at a neutral point. The inverter includes switching elements, and includes pairs of upper and lower arms corresponding to the respective stator windings of the multiple phases. The inverter converts direct-current electric power into alternating-current electric power and supplies the alternating-current electric power to the electric motor. The processor controls driving of the inverter. Upon detecting a stuck-short or stuck-open state of ones of the switching elements corresponding to one of the multiple phases, the processor enters into a fail-safe operation of turning on ones of the switching elements in the upper or lower arms for all the multiple phases, and thereafter causes a weld at the neutral point to be broken.

### CROSS-REFERENCE TO RELATED APPLICATIONS

The present application claims priority from Japanese Patent Application No. 2025-061672 filed on Apr. 3, 2025, the entire contents of which are hereby incorporated by reference.

### BACKGROUND

The disclosure relates to an electric motor driving apparatus.

A hybrid electric vehicle (HEV) has been widely put into practical use. The HEV allows for effective improvement of vehicle fuel economy by combination use of an engine and an electric motor. Further, a battery electric vehicle (BEV) has also been put into practical use. The BEV uses an electric motor alone as a motive power source, and discharges no exhaust gas. In each of the HEV and BEV as an electric vehicle including the electric motor as the motive power source, the electric motor is driven through an inverter including switching elements. The inverter converts direct-current electric power of a high voltage battery into alternating-current electric power, such as three-phase alternating-current electric power, and supplies the converted electric power to the electric motor to thereby drive the electric motor.

When, for example, any of the switching elements included in the inverter become stuck open or stuck short, it becomes difficult to properly pass a current and accordingly, a sum of currents for multiple phases, such as three phases, can get out of balance. This can lead to generation of an unintended torque, i.e., an abnormal torque.

To address this, for example, Japanese Unexamined Patent Application Publication No. 2020-65341 discloses a technique of performing a fail-safe operation, with a permanent magnet synchronous motor driving system, upon detection of a stuck-short or stuck-open state of any of semiconductor switching elements included in an inverter. In the fail-safe operation, ones of the switching elements in upper arms or lower arms of the inverter for all phases are turned on while avoiding any short circuit between the upper and lower arms, based on a balance state of output currents of the respective phases.

### SUMMARY

An aspect of the disclosure provides an electric motor driving apparatus. The electric motor driving apparatus includes an electric motor, an inverter, and a processor. The electric motor includes a stator. The stator includes a set of stator windings of multiple phases. The stator windings of the multiple phases are coupled to each other at a neutral point. The inverter includes switching elements, and includes pairs of upper and lower arms, the pairs corresponding to the respective stator windings of the multiple phases. The inverter is configured to convert direct-current electric power into alternating-current electric power of the multiple phases by turning on and off the respective switching elements included in the upper arms and the lower arms, and to supply the alternating-current electric power to the electric motor. The processor is configured to control driving of the inverter by executing a program stored in a memory. The processor is configured to, upon detecting a stuck-short or stuck-open state of ones of the switching elements that correspond to one of the multiple phases, enter into a fail-safe operation of turning on ones of the switching elements in the upper or lower arms for all the multiple phases and thereafter cause a weld at the neutral point of the stator windings to be broken.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a diagram illustrating a configuration of an electric motor driving apparatus according to one example embodiment of the disclosure.

FIG. 2A is a diagram illustrating a temperature distribution obtained from a break simulation on a weld at a neutral point of a stator winding.

FIG. 2B is a diagram illustrating a stress distribution obtained from the break simulation on the weld at the neutral point of the stator winding.

FIG. 3 is a flowchart of a processing procedure of fail-safe processing, i.e., processing to break the neutral point, to be executed by the electric motor driving apparatus according to the example embodiment.

### DETAILED DESCRIPTION

In a multi-phase inverter of, for example, an electric vehicle, a situation can occur in which ones of switching elements of the inverter that correspond to one of the multiple phases become stuck open or stuck short. In such a case, turning on ones of the switching elements in upper or lower arms for all the phases can cause an abnormal current to flow through a device such as an electric motor or the inverter, and can thus cause such a device to be broken or damaged.

It is desirable to provide an electric motor driving apparatus that makes it possible to prevent a flow of an abnormal current during a fail-safe operation of turning on switching elements in upper or lower arms for all of multiple phases in an inverter when a stuck-short or stuck-open state is detected for ones of the switching elements that correspond to one of the multiple phases, and thereby makes it possible to prevent, for example, damage to an electric motor, the inverter, and other devices.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

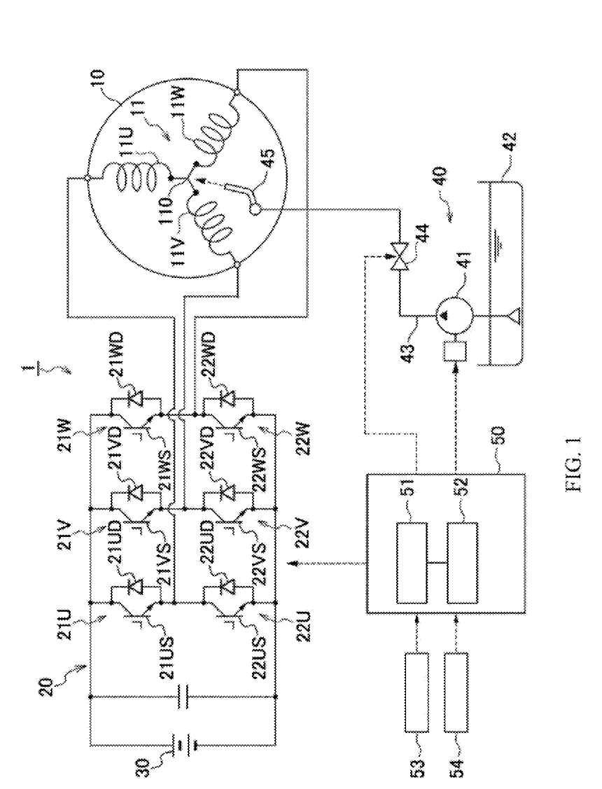

First, with reference to FIG. 1, a description will be given of a configuration of an electric motor driving apparatus 1 according to an example embodiment. FIG. 1 illustrates the configuration of the electric motor driving apparatus 1.

The electric motor driving apparatus 1 includes an electric motor 10. The electric motor 10 may be, for example, a three-phase alternating-current synchronous motor, and may serve as a source of a driving force that drives an electric vehicle. Further, the electric motor 10 may be a permanent-magnet (PM) synchronous motor including a permanent magnet as an unillustrated rotor and a set of stator windings (armature windings) 11 of multiple phases as a stator. In the example embodiment, the multiple phases may include three phases, i.e., a U phase, a V phase, and a W phase. The set of stator windings 11 of the multiple (three) phases included in the stator of the electric motor 10 may include stator windings 11U, 11V, and 11W. The stator windings 11U, 11V, and 11W have their respective first ends coupled (e.g., welded) to each other at a neutral point 110. It is to be noted that the reference numeral 110 is also used to denote a "neutral line" in the following description.

Hereinafter, the stator windings 11U, 11V, and 11W may be referred to as "three-phase stator windings 11U, 11V, and 11W" or may be collectively referred to as "stator windings 11", the stator winding 11U may be referred to as a "U-phase stator winding 11U", the stator winding 11V may be referred to as a "V-phase stator winding 11V", the stator winding 11W may be referred to as a "W-phase stator winding 11W", and each of or any one of the stator windings 11U, 11V, and 11W may be referred to as a "stator winding 11".

A temperature sensor 53 that detects a temperature of the stator winding 11 of the electric motor 10 may be attached to the stator winding 11. The temperature sensor 53 may be coupled to a control unit (CU) 50 to be described later. The CU 50 may receive an electric signal, such as a voltage, corresponding to the temperature of the stator winding 11.

The electric motor 10 may include, for example, an oil-cooled (i.e., a liquid-cooled) electric motor to be cooled with an oil serving as a liquid coolant. The oil (i.e., a cooling oil) may be pressurized by an electric oil pump 41 and directly supplied to the stator through a nozzle 45 to thereby cool the electric motor 10.

To that end, the electric motor 10 may be provided with an oil jet device (or an oil supply device) 40 that jets the oil to the stator winding 11 (e.g., to the neutral point 110). The oil jet device 40 may, for example, pressurize the oil stored in an oil pan 42 using the electric oil pump 41, supply the oil with pressure to the nozzle 45 through an oil passage (or an oil pressure circuit) 43, and cause the oil to jet out of the nozzle 45 to the stator winding 11 (e.g., to the neutral point 110). The oil passage (or the oil pressure circuit) 43 may be provided with an on/off valve 44, or a solenoid valve, that brings an oil jet into an operating state or a stopped state, i.e., that switches between the operating state and the stopped state of the oil jet. The CU 50 to be described later may control driving of the electric oil pump 41 (and the on/off valve 44), i.e., supply and stop of the supply of the oil. Details will be described later.

An oil temperature sensor 54 that detects a temperature of the oil, i.e., an oil temperature, may be attached to the oil jet device 40. The oil temperature sensor 54 may be coupled to the CU 50. The CU 50 may receive an electric signal, such as a voltage, corresponding to the oil temperature.

The inverter 20 includes switching elements 21US, 21VS, 21WS, 22US, 22VS, and 22WS. The inverter 20 includes multiple (or three-phase) upper arms 21U, 21V, and 21W respectively corresponding to the three-phase stator windings 11U, 11V, and 11W described above, and multiple (or three-phase) lower arms 22U, 22V, and 22W respectively corresponding to the three-phase stator windings 11U, 11V, and 11W described above. The inverter 20 may turn on and off the switching elements 21US, 21VS, and 21WS included in the upper arms 21U, 21V, and 21W and the switching elements 22US, 22VS, and 22WS included in the lower arms 22U, 22V, and 22W in a complementary manner to thereby convert direct-current electric power of a high-voltage battery 30 into multi-phase (i.e., three-phase) alternating-current electric power and supply the alternating-current electric power to the electric motor 10, that is, drive the electric motor 10.

In one example, the inverter 20 may include the three-phase upper and lower arms 21U and 22U, 21V and 22V, and 21W and 22W that include respective paired switching elements (i.e., the switching elements 21US and 22US, the switching elements 21VS and 22VS, and the switching elements 21WS and 22WS), the paired switching elements being coupled in series to each other. Respective coupling points, or coupling nodes, between the upper and lower arms 21U and 22U, 21V and 22V, and 21W and 22W of the respective phases may each be coupled to corresponding one of the stator windings 11U, 11V, and 11W.

Thus, the inverter 20 includes pairs of upper and lower arms 21U and 22U, 21V and 22V, and 21W and 22W that respectively correspond to the three-phase stator windings 11U, 11V, and 11W of the electric motor 10. The upper arm 21U and the lower arm 22U of the U phase may be coupled in series to each other, and the coupling point, or coupling node, between the upper arm 21U and the lower arm 22U may be coupled to a second end of the U-phase stator winding 11U of the electric motor 10.

Similarly, the upper arm 21V and the lower arm 22V of the V phase may be coupled in series to each other, and the coupling point, or coupling node, between the upper arm 21V and the lower arm 22V may be coupled to a second end of the V-phase stator winding 11V of the electric motor 10. Further, the upper arm 21W and the lower arm 22W of the W phase may be coupled in series to each other, and the coupling point, or coupling node, between the upper arm 21W and the lower arm 22W may be coupled to a second end of the W-phase stator winding 11W of the electric motor 10.

The upper arms 21U, 21V, and 21W may include freewheeling diodes 21UD, 21VD, and 21WD, respectively. The lower arms 22U, 22V, and 22W may include freewheeling diodes 22UD, 22VD, and 22WD, respectively. The freewheeling diodes 21UD, 21VD, 21WD, 22UD, 22VD, and 22WD may be coupled in anti-parallel to the switching elements 21US, 21VS, 21WS, 22US, 22VS, and 22WS, respectively. For example, metal-oxide-semiconductor field-effect transistors (MOSFETs), insulated gate bipolar transistors (IGBT), or other transistors may be used as the switching elements 21US, 21VS, 21WS, 22US, 22VS, and 22WS. The switching elements 21US, 21VS, and 21WS and the switching elements 22US, 22VS, and 22WS may be turned on and off in a complementary manner through switching signals from the CU 50. In other words, driving of the inverter 20 may be controlled by the CU 50.

The CU 50 may control the electric motor 10 by performing switching control on the inverter 20, that is, by controlling the driving of the inverter 20. Further, the CU 50 may control the driving of the electric oil pump 41 (and/or the on/off valve 44) to thereby control the oil jet device 40 to operate or stop, that is, control supply and stop of the supply of the oil to the stator. Details will be described later.

The above-described temperature sensor 53 that detects the temperature of the stator winding 11 and the above-described oil temperature sensor 54 that detects the temperature of the oil (i.e., the cooling oil) may be coupled to the CU 50.

The CU 50 may include, for example but not limited to, a microprocessor 51, an electrically erasable programmable read-only memory (EEPROM) 52, a random access memory (RAM), a backup RAM, and an input and output interface (I/F). The microprocessor 51 may perform calculation. The EEPROM 52 may hold, for example but not limited to, a program that causes the microprocessor 51 to execute processing. The RAM may hold various kinds of data including, without limitation, a calculation result. The backup RAM may hold contents stored in the RAM. In one embodiment, the microprocessor 51 may serve as a "processor". In one embodiment, the EEPROM 52 may serve as a "memory".

For example, the CU 50, or the microprocessor 51, may be configured to, upon detecting a stuck-short or stuck-open state of ones of the switching elements 21US, 21VS, 21WS, 22US, 22VS, and 22WS of the inverter 20 that correspond to one of the three phases, perform a fail-safe operation (a limp-home mode) of turning on the switching elements 21US, 21VS, and 21WS in the upper arms 21U, 21V, and 21W for all the three phases or the switching elements 22US, 22VS, and 22WS in the lower arms 22U, 22V, and 22W for all the three phases while avoiding any short circuit between the upper and lower arms 21U and 22U, 21V and 22V, and 21W and 22W of the inverter 20, and also to prevent a flow of an abnormal current during the fail-safe operation to thereby prevent the electric motor 10, the inverter 20, and other devices from being broken or damaged, for example. In the CU 50, the above-described operation may be achieved by execution of a program, by the microprocessor 51, that is stored in the EEPROM 52 (the memory) or any other memory. Hereinafter, the microprocessor 51 may be simply referred to as a processor 51.

Accordingly, upon detecting the stuck-short or stuck-open state of ones of the switching elements 21US, 21VS, 21WS, 22US, 22VS, and 22WS that correspond to one of the three phases, the processor 51 in the CU 50 may enter into the fail-safe operation of turning on the switching elements 21US, 21VS, and 21WS in the upper arms 21U, 21V, and 21W for all the three phases or the switching elements 22US, 22VS, and 22WS in the lower arms 22U, 22V, and 22W for all the three phases while avoiding any short circuit between the upper and lower arms 21U and 22U, 21V and 22V, and 21W and 22W of the inverter 20. For example, when the stuck-open state occurs in one of the upper arms 21U, 21V, and 21W, the processor 51 may turn on the switching elements in all the lower arms 22U, 22V, and 22W. For example, when the stuck-short state occurs in one of the upper arms 21U, 21V, and 21W, the processor 51 may turn on the switching elements in all the upper arms 21U, 21V, and 21W and turn off the switching elements in all the lower arms 22U, 22V, and 22W. After entering into the above-described fail-safe operation, the processor 51 causes a weld at the neutral point 110 of the stator winding 11 to be broken.

Thus, upon detecting the stuck-short or stuck-open state of ones of the switching elements 21US, 21VS, 21WS, 22US, 22VS, and 22WS that correspond to one of the three phases, the CU 50 may enter into the fail-safe operation of turning on the switching elements 21US, 21VS, and 21WS in the upper arms 21U, 21V, and 21W for all the three phases or the switching elements 22US, 22VS, and 22WS in the lower arms 22U, 22V, and 22W for all the three phases while avoiding any short circuit between the upper and lower arms 21U and 22U, 21V and 22V, and 21W and 22W of the inverter 20, and thereafter cause the weld at the neutral point 110 of the stator winding 11 to be broken.

This brings each of the three-phase stator windings 11U, 11V, and 11W into a decoupled or nonconducting state, which helps to prevent a flow of an abnormal current. Here, any of known methods may be used to detect the stuck-short or stuck-open state of ones of the switching elements 21US, 21VS, 21WS, 22US, 22VS, and 22WS that correspond to one of the three phases. Non-limiting examples of the known methods may include a detection method based on, for example, a loss of balance of the sum of currents for the three phases, i.e., an out-of-balance state of the currents for the three phases.

In this case, the processor 51 of the CU 50 may cause the weld at the neutral point 110 to be broken (ruptured) by causing a thermal stress to act on the weld. For example, after entering into the fail-safe operation, the processor 51 of the CU 50 may temporarily stop driving the electric oil pump 41 or temporarily close the on/off valve 44 to thereby stop the supply of the oil (i.e., the cooling oil). Thereafter, when the temperature of the stator winding 11 increases and a temperature difference between the stator winding 11 and the oil (i.e., the cooling oil) thus becomes greater than or equal to a predetermined temperature (e.g., 160°C), the processor 51 may redrive the electric oil pump 41 or open the on/off valve 44 and cause the oil (i.e., the cooling oil) to be jetted onto the weld at the neutral point 110.

In some embodiments, the respective first ends of the three-phase stator windings 11U, 11V, and 11W may be positioned at a distance from each other and welded (i.e., coupled) to each other via a neutral line 110. In other words, the foregoing weld may include three separate welds that are individually provided at a distance from each other, that is, a weld between the U-phase stator winding 11U and the neutral line 110, a weld between the V-phase stator winding 11V and the neutral line 110, and a weld between the W-phase stator winding 11W and the neutral line 110. In such a case, the oil (i.e., the cooling oil) may be jetted onto one side, that is, either the stator winding 11 (i.e., the U-phase stator winding 11U, the V-phase stator winding 11V, or the W-phase stator winding 11W) or the neutral line 110 at each of the welds. The nozzle 45 may thus be so disposed as to allow the oil to reach either the stator winding 11 or the neutral line 110. As a result, the weld at the neutral point, or the neutral line, 110 may be broken by a thermal stress due to a temperature difference between each of the stator windings 11 (i.e., each of the U-phase stator winding 11U, the V-phase stator winding 11V, and the W-phase stator winding 11W) and the neutral line 110.

In some embodiments, the respective first ends of the three-phase stator windings 11U, 11V, and 11W may be aligned at one location and welded (i.e., coupled) to each other. In such a case, the oil (i.e., the cooling oil) may be jetted onto two of the stator windings 11U, 11V, and 11W positioned at opposite ends of the weld or onto one of the stator windings 11U, 11V, and 11W positioned in the middle. The nozzle 45 may thus be so disposed as to allow the oil to reach the two of the stator windings 11U, 11V, and 11W positioned at opposite ends of the weld or the one of the stator windings 11U, 11V, and 11W positioned in the middle. As a result, the weld at the neutral line, or the neutral point, 110 may be broken by a thermal stress due to a temperature difference between the stator windings 11 (i.e., the U-phase stator winding 11U, the V-phase stator winding 11V, and the W-phase stator winding 11W).

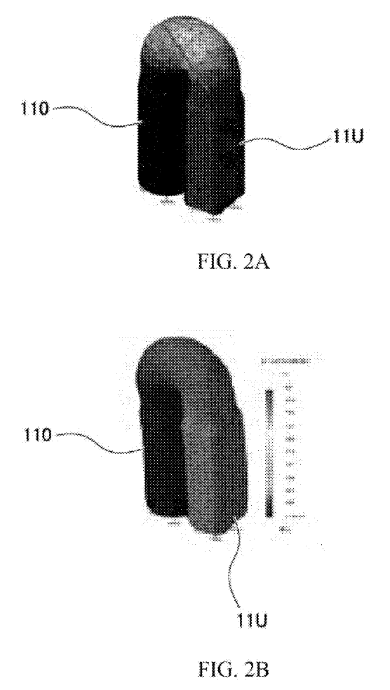

FIGS. 2A and 2B each illustrate a result of a break simulation on the weld at the neutral point 110 of the stator winding 11. FIG. 2A illustrates a temperature distribution. FIG. 2B illustrates a stress distribution. Used in the simulation was a technique of thermal stress analysis using ATH (Thermal Analysis). Respective models of the stator winding 11 (e.g., the U-phase stator winding 11U), the neutral line 110, and the weld were integrated with each other, and respective base ends of the stator winding 11 (e.g., the U-phase stator winding 11U) and the neutral line 110 were completely restrained. The simulation revealed that when the temperature of the stator winding 11 (e.g., the U-phase stator winding 11U) was 200°C and the temperature of the neutral line 110 was 40°C, a von Mises stress on an inner side of the weld exceeded 195 MPa, which made it possible for the weld to be broken by the thermal stress. This indicates that when, for example, the oil temperature is 60°C, increasing the temperature of the stator winding 11 to 220°C (< heat resistance temperature) allows a temperature difference between the oil and the stator winding 11 to be 160°C, which will allow the weld at the neutral point 110 to be broken by the thermal stress.

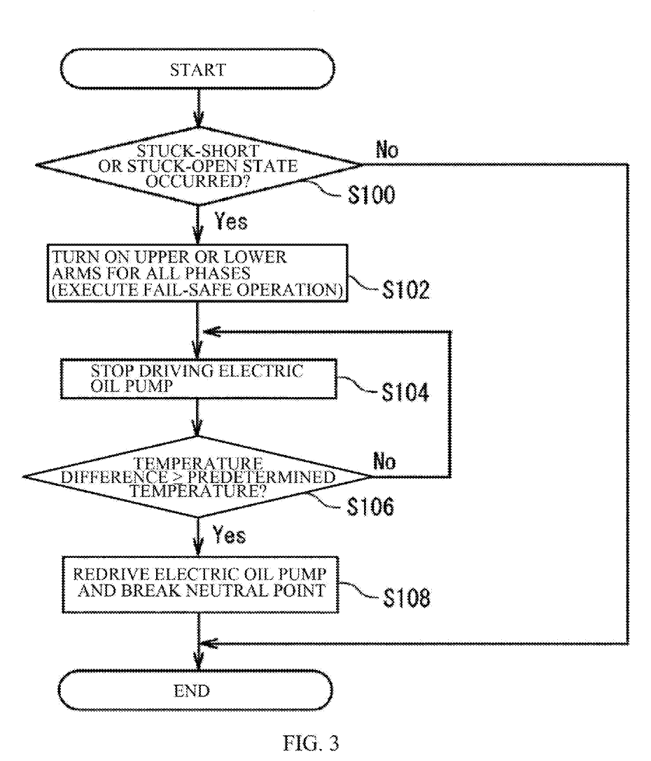

An operation of the electric motor driving apparatus 1 will now be described with reference to FIG. 3. FIG. 3 is a flowchart of a processing procedure of fail-safe processing, i.e., processing to break the neutral point, to be executed by the electric motor driving apparatus 1. The processing may be repeatedly executed at predetermined timings by, for example, the microprocessor 51 in the CU 50.

In step S100, a determination may be made as to whether a stuck-short or stuck-open state is detected for ones of the switching elements 21US, 21VS, 21WS, 22US, 22VS, and 22WS, of the inverter 20 that correspond to one of the three phases. If no stuck-short or stuck-open state is detected for any one of the three phases, the processing may temporarily end. If a stuck-short or stuck-open state is detected for any one of the three phases, the processing may proceed to step S102.

In step S102, the switching elements 21US, 21VS, and 21WS in the upper arms 21U, 21V, and 21W for all the three phases or the switching elements 22US, 22VS, and 22WS in the lower arms 22U, 22V, and 22W for all the three phases may be turned on while avoiding any short circuit between the upper and lower arms 21U and 22U, 21V and 22V, and 21W and 22W of the inverter 20. In other words, the fail-safe operation may be executed.

Thereafter , in step S104, the driving of the electric oil pump 41 may be temporarily stopped, or the on-off valve 44 may be temporarily closed. Accordingly, the supply of the oil may be stopped and the stator winding 11 may thus increase in temperature.

Thereafter, in step S106, a determination may be made as to whether the temperature difference between the stator winding 11 and the oil (i.e., the cooling oil) is greater than or equal to a predetermined temperature (e.g., 160°C). If the temperature difference is not yet greater than or equal to the predetermined temperature, the processing may return to step S104, and the foregoing processing of steps S104 to S106 may be repeatedly executed until the temperature difference becomes greater than or equal to the predetermined temperature. When the temperature difference becomes greater than or equal to the predetermined temperature, the processing may proceed to step S108.

In step S108, the electric oil pump 41 may be redriven, or the on/off valve 44 may be reopened to cause the oil (i.e., the cooling oil) to be jetted onto the weld at the neutral point 110 of the stator winding 11. How to jet the oil (i.e., the cooling oil) onto the weld at the neutral point 110 of the stator winding 11 is as described above, and a detailed description thereof is thus omitted here. Thereafter, the weld at the neutral point 110 may be caused to be broken by the thermal stress due to the above-described temperature difference. Thereafter, the processing may end.

As has been described in detail above, according to the example embodiment, when the stuck-short or stuck-open state is detected for ones of the switching elements 21US, 21VS, 21WS, 22US, 22VS, and 22WS of the inverter 20 that correspond to one of the three phases, the weld at the neutral point 110 of the stator winding 11 may be broken after entry into the fail-safe operation of turning on the switching elements 21US, 21VS, and 21WS in the upper arms 21U, 21V, and 21W for all the three phases or the switching elements 22US, 22VS, and 22WS in the lower arms 22U, 22V, and 22W for all the three phases while avoiding any short circuit between the upper and lower arms 21U and 22U, 21V and 22V, and 21W and 22W of the inverter 20. This helps to prevent an abnormal current from flowing through the electric motor 10, the inverter 20, and other devices during the fail-safe operation, which in turn helps to prevent, for example, damage to the electric motor 10, the inverter 20, and other devices.

In some embodiments, after entry into the fail-safe operation, the driving of the electric oil pump 41 may be temporarily stopped, or the on/off valve 44 may be temporarily opened, and when the temperature of the stator winding 11 increases and the temperature difference the stator winding 11 and the oil (i.e., the cooling oil) thus becomes greater than or equal to the predetermined temperature (e.g., 160°C), the electric oil pump 41 may be redriven or the on/off valve 44 may be reopened to cause the oil (i.e., the cooling oil) to be jetted onto the weld at the neutral point 110. This helps to cause the weld at the neutral point 110 to be broken by a thermal stress due to a temperature difference between the stator winding 11 and the neutral point, or the neutral line, 110. Further, this helps to achieve the breaking of the weld at the neutral point 110 without addition of any dedicated component, such as a pilot fuse.

In some embodiments, the respective first ends of the three-phase stator windings 11U, 11V, and 11W may be positioned at a distance from each other and welded (i.e., coupled) to each other via the neutral line 110. In other words, the foregoing weld may include three separate welds that are individually provided at a distance from each other, that is, the weld between the U-phase stator winding 11U and the neutral line 110, the weld between the V-phase stator winding 11V and the neutral line 110, and the weld between the W-phase stator winding 11W and the neutral line 110. In such a case, the oil (i.e., the cooling oil) may be jetted onto one side, that is, either the stator winding 11 (i.e., the U-phase stator winding 11U, the V-phase stator winding 11V, or the W-phase stator winding 11W) or the neutral line 110 at each of the welds. This helps to produce a temperature difference between each of the stator windings 11 (i.e., each of the U-phase stator winding 11U, the V-phase stator winding 11V, and the W-phase stator winding 11W) and the neutral line 110, and thus helps to cause the weld at the neutral point, or the neutral line, 110 to be broken by a thermal stress due to the temperature difference.

In some embodiments, the respective first ends of the three-phase stator windings 11U, 11V, and 11W may be aligned at one location and welded (i.e., coupled) to each other. In such a case, the oil (i.e., the cooling oil) may be jetted onto two of the stator windings 11U, 11V, and 11W positioned at opposite ends of the weld or onto one of the stator windings 11U, 11V, and 11W positioned in the middle. This helps to produce a temperature difference between the stator windings 11 (i.e., the U-phase stator winding 11U, the V-phase stator winding 11V, and the W-phase stator winding 11W), and thus helps to cause the weld at the neutral point 110 to be broken by a thermal stress due to the temperature difference.

Although the disclosure has been described hereinabove in terms of the example embodiment, the disclosure is not limited thereto. It should be appreciated that variations may be made in the described example embodiment and modification examples by those skilled in the art without departing from the scope of the disclosure as defined by the following claims.

For example, the foregoing example embodiment has been described with reference to a case in which the disclosure is applied to a permanent-magnet (PM) synchronous motor. However, the disclosure is also applicable to, for example, any of other types of electric motors including, without limitation, an alternating-current induction motor (IM). Further, the disclosure is applicable to any electric vehicle that includes an electric motor as a driving force source. Non-limiting examples of such an electric vehicle may include a battery electric vehicle (BEV), a hybrid electric vehicle (HEV), a plug-in hybrid electric vehicle (PHEV), and a fuel cell electric vehicle (FCEV). The disclosure may also be applied to an electric vehicle including multiple electric motors.

Although the electric motor 10 and the inverter 20 used in the example embodiment may be of three phases, the number of phases of the electric motor and the inverter is not limited to three.

The electric motor driving apparatus according to at least one embodiment of the disclosure makes it possible to prevent a flow of an abnormal current during a fail-safe operation of turning on switching elements in upper or lower arms for all of multiple phases in an inverter when a stuck-short or stuck-open state is detected for ones of the switching elements that correspond to one of the multiple phases. The electric motor driving apparatus thereby makes it possible to prevent, for example, damage to the electric motor, the inverter, and other devices.

The limitations in the claims are to be interpreted broadly based on the language employed in the claims and not limited to examples described in this specification or during the prosecution of the application, and the examples are to be construed as non-exclusive.

As used in this specification and the appended claims, the singular forms "a", "an", and "the" include, especially in the context of the claims, are to be construed to cover both the singular and the plural, unless otherwise indicated herein or clearly contradicted by context.

Throughout this specification and the appended claims, unless the context requires otherwise, the terms "comprise", "include", "have", and their variations are to be construed to cover the inclusion of a stated element, integer, or step but not the exclusion of any other non-stated element, integer, or step.

The use of the terms first, second, etc. does not denote any order or importance, but rather the terms first, second, etc. are used to distinguish one element from another.

The term "substantially", "approximately", "about", and its variants having a similar meaning thereto are defined as being largely but not necessarily wholly what is specified as understood by one of ordinary skill in the art.

The term "disposed on/ provided on/ formed on" and its variants having a similar meaning thereto as used herein refer to elements disposed directly in contact with each other or indirectly by having intervening structures therebetween.

The microprocessor 51 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the microprocessor 51 illustrated in FIG. 1. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the microprocessor 51 illustrated in FIG. 1.

1. An electric motor driving apparatus comprising:
an electric motor comprising a stator, the stator comprising a set of stator windings of multiple phases, the stator windings of the multiple phases being coupled to each other at a neutral point;
an inverter comprising switching elements, and comprising pairs of upper and lower arms, the pairs corresponding to the respective stator windings of the multiple phases, the inverter being configured to convert direct-current electric power into alternating-current electric power of the multiple phases by turning on and off the respective switching elements included in the upper arms and the lower arms, and to supply the alternating-current electric power to the electric motor; and
a processor configured to control driving of the inverter by executing a program stored in a memory, wherein
the processor is configured to, upon detecting a stuck-short or stuck-open state of ones of the switching elements that correspond to one of the multiple phases, enter into a fail-safe operation of turning on ones of the switching elements in the upper or lower arms for all the multiple phases and thereafter cause a weld at the neutral point of the stator windings to be broken.

2. The electric motor driving apparatus according to claim 1, wherein the processor is configured to cause the weld at the neutral point to be broken by causing a thermal stress to act on the weld.

3. The electric motor driving apparatus according to claim 2, wherein
the electric motor comprises a liquid-cooled electric motor configured to be cooled with a liquid coolant pressurized by an electric oil pump and supplied to the stator, and
the processor is configured to, after entering into the fail-safe operation, temporarily stop supply of the liquid coolant, and when a temperature difference between any one of the stator windings and the liquid coolant becomes greater than or equal to a predetermined temperature, restart the supply of the liquid coolant and cause the liquid coolant to be jetted onto the weld at the neutral point.

4. The electric motor driving apparatus according to claim 3, wherein
the stator windings of the multiple phases have their respective one ends positioned at a distance from each other and welded to each other via a neutral line,
the weld comprises a plurality of the welds, the welds being between the respective one ends of the stator windings and the neutral line, and
the processor is configured to cause the liquid coolant to be jetted onto either relevant one of the stator windings or the neutral line at each of the welds.

5. The electric motor driving apparatus according to claim 3, wherein
the multiple phases comprise three phases,
the stator windings of the three phases have their respective one ends aligned at one location and welded to each other, and
the processor is configured to cause the liquid coolant to be jetted onto two of the stator windings positioned at opposite ends of the weld, or onto one of the stator windings positioned in a middle.
